(19) United States
(12) Patent Application Publication
(10) Pub. No.: US 2006/0046789 A1
(43) Pub. Date: Mar. 2, 2006

(54) Apparatus and method for controlling uplink power in a mobile communication system using a TDD scheme

(75) Inventors: Hoon Huh, Seongnam-si (KR); Jae-Hee Cho, Seoul (KR); In-Seok Hwang, Seoul (KR); Eun-Sun Choi, Seoul (KR); Soon-Young Yoon, Seoul (KR); Sang-Hoon Sung, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/204,801

(22) Filed: Aug. 16, 2005

(30) Foreign Application Priority Data
Aug. 16, 2004 (KR) 64464/2004

(51) Int. Cl. H04B 1/38

(52) U.S. Cl. 455/571; 455/82

(57) ABSTRACT

An apparatus and a method for controlling uplink power utilizing an open-loop scheme in a mobile communication system using a TDD scheme. According to the apparatus and the method, an AT determines initial uplink transmit power and transmits uplink signals to an AP using the determined initial uplink transmit power, receives downlink signals from the AP, detects a power compensation value compensating for the uplink transmit power, which are determined according to whether an error has occurred in the uplink signals, measures receive power of the downlink signals, and adjusts the uplink transmit power according to the receive power and the power compensation value.

### PRIORITY

This application claims priority to an application entitled “Apparatus and Method For Controlling Uplink Power in Mobile Communication System Using TDD Scheme” filed in the Korean Intellectual Property Office on Aug. 16, 2004 and assigned Serial No. 2004-64464, the content of which is incorporated herein by reference.

### BACKGROUND OF THE INVENTION

1. Field of the Invention

The present invention relates generally to an apparatus and a method for controlling power in a mobile communication system, and more particularly to an apparatus and a method for controlling uplink power utilizing an open-loop scheme in a mobile communication system using a Time Division Duplexing (TDD) scheme.

2. Description of the Related Art

Generally, a duplexing scheme used in a mobile communication system may be classified into a Frequency Division Duplexing (FDD) scheme for duplexing uplink and downlink transmission based on a frequency and a TDD scheme for duplexing uplink and downlink transmission based on time. In an FDD scheme, uplink and downlink are duplexed using different frequencies. Accordingly, a transmission side, e.g., a Base Transceiver Station (BTS), and a reception side, e.g., a Mobile Station (MS), must independently have a transmit antenna Tx ANT and a receive antenna Rx ANT, respectively.

In a TDD scheme, in contrast with the FDD scheme, an uplink and a downlink are duplexed using time instead of a frequency. Accordingly, a transmission side and a reception side may transmit and receive signals through one antenna installed in each of the two sides. That is, when the TDD scheme is used, because uplink and downlink use the same frequency, an uplink time slot for transmitting uplink signals and a downlink time slot for transmitting downlink signals are differentiated in advance, such that only the uplink signals are transmitted during the uplink time slot and only the downlink signals are transmitted during the downlink time slot.

In the TDD scheme, the complexity of scheduling for transmission and reception of uplink and downlink signals may increase as compared with the FDD scheme. However, the TDD scheme is quite efficient in its use of frequencies, thereby achieving positive efficiency of resources.

Further, a multiple access scheme used in a mobile communication system can be classified into a Code Division Multiple Access (CDMA) scheme, a Frequency Division Multiple Access (FDMA) scheme, and a Time Division Multiple Access (TDMA) scheme. The CDMA scheme multiplexes MSs based on a code in order to support connection, the FDMA scheme multiplexes the MSs based on a frequency in order to support connection, and the TDMA scheme multiplexes the MSs based on time in order to support_connection. Further, the CDMA scheme may be classified into a Wideband Code Division Multiple Access (WCDMA) scheme for supporting multiple access by means of an asynchronous scheme, and a CDMA-2000 scheme for supporting multiple access by means of a synchronous scheme.

FIG. 1 is a block diagram schematically illustrating a conventional WCDMA-TDD mobile communication system. Referring to FIG. 1, the WCDMA-TDD mobile communication system includes a Core Network (CN) 101, a Base Station Controller (BSC) 103, a BTS 105, and a plurality of MSs 107-1 to 107-n.

In FIG. 1, the CN 101 is connected to only one BSC 103. However, the CN 101 may also be connected to a plurality of BSCs. Further, the CN 101 is connected to the BSC 103 by wire. The BSC 103 is connected to only one BTS 105, but like the CN 101, the BSC 103 may also be connected to a plurality of BTSs. Further, the BSC 103 is connected to the BTS 105 by wire.

The CN 101 manages position information based on the position change of the MSs 107-1 to 107-n, and performs an authentication operation, call connection operation, etc. The BSC 103 controls radio resource allocation of the BTS 105, and the BTS 105 transmits information, e.g., System Information (SI), which must be commonly received in MSs, i.e., the MSs 107-1 to 107-n, which exist in a service coverage of the BTS 105, through a Broadcast Channel (BCH).

Further, the BTS 105 transmits a control message or traffic data targeting each of the MSs 107-1 to 107-n through a Dedicated Channel (DCH), and receives signals transmitted from each of the MSs 107-1 to 107-n. Herein, a duplexing scheme between the BTS 105 and the MSs 107-1 to 107-n is the TDD scheme and a multiple access scheme between the BTS 105 and the MSs 107-1 to 107-n is the WCDMA scheme.

FIG. 2 is a diagram schematically illustrating an uplink and a downlink frame in the WCDMA-TDD mobile communication system. Referring to FIG. 2, when the TDD scheme as described above is used, the downlink frame 210 and the uplink frame 230 are transmitted only during corresponding time slots in the same frequency band. That is, the downlink frame 210 is transmitted during a downlink time slot and then the uplink frame 230 is transmitted during an uplink time slot after a Transmit/receive Transition Gap (TTG) 220 time slot passes. After the uplink frame 230 is transmitted and a Receive/transmit Transition Gap (RTG) 240 time slot passes, another downlink frame is transmitted during a downlink time slot. Herein, no signals are transmitted during the TTG 220 time slot and the RTG 240 time slot.

The TTG 220 time slot is a time slot during which transition from the downlink to the uplink is performed and the RTG 240 time slot is a time slot during which transition from the uplink to the downlink is performed. That is, the TTG 220 time slot and the RTG 240 time slot are established to prevent interference between uplink and downlink signals, which may occur due to sharing of the same frequency band by the uplink and the downlink because of characteristics of the TTD scheme.

Further, BCH signals 211 are transmitted at initial start time point of the downlink frame 210. The BCH is a channel for transmitting information that must be commonly received in all MSs existing in a service coverage of a corresponding BTS, as described FIG. 1. Further, Downlink-bursts (DL-bursts), i.e., DL-bursts 213 and 215, targeting corresponding MSs are sequentially transmitted after the BCH signals 211. The corresponding MSs receive downlink data during time slots, i.e., downlink burst intervals, which are allocated to each of the corresponding MS, and information for the downlink burst time interval, which each MS must receive, has been stipulated between the BTS and the MSs.

The uplink frame 230 includes a plurality of Uplink bursts (UL-bursts), i.e., UL-bursts 231 and 233, and the corresponding MSs transmit uplink data during time slots, i.e., uplink burst intervals, which are allocated to each of the corresponding MS. Herein, information for the downlink burst time interval during which each MS must transmit the uplink data has been stipulated between the BTS and the MSs.

In order to increase system capacity and provide a service of high quality, a conventional mobile communication system performs downlink and uplink power control. The downlink power control represents power control for signals transmitted from a transmission side to a reception side, and the uplink power control represents power control for signals transmitted from the reception side to the transmission side. For convenience of description, it is assumed that the transmission side corresponds to the BTS and the reception side corresponds to the MS.

The BTS controls transmit power of all MSs existing in a service coverage of the BTS in communication with the MSs. Accordingly, when signals transmitted from the MSs satisfy a target Signal-to-Interference Noise Ratio (SINR), the system capacity may be maximized. If transmit power allocated to a specific MS of the MSs is excessively set to have a SINR exceeding the target SINR, the transmit performance of the specific MS may be improved. However, signals transmitted from the specific MS may act as interference to other MSs.

As described above, the WCDMA-TDD mobile communication system includes a plurality of BSCs, a plurality of BTSs, and a plurality of MSs. Each of the BTSs performs downlink Transmit Power Control (TPC) and uplink TPC in order to maximally control interference between MSs existing in its own service coverage and interference to another BTS. The downlink TPC scheme controls the transmit power level of downlink signals transmitted from the BTS to the MS, and the uplink TPC scheme controls the transmit power level of uplink signals transmitted from the MS to the BTS. The downlink TPC scheme and the uplink TPC scheme control transmit power using a power control scheme such as an open-loop power control scheme, a closed-loop power control scheme, and an outer-loop power control scheme.

Hereinafter, the power control scheme, i.e., the open-loop power control scheme, the closed-loop power control scheme, and the outer-loop power control scheme will be described. In particular, the open-loop power control scheme, the closed-loop power control scheme, and the outer-loop power control scheme will be described using the uplink TPC as an example.

In the open-loop power control scheme, an MS measures path loss for signals of a specific channel, e.g., a first Primary Common Control Physical Channel (P-CCPCH), received from a BTS providing a service to the MS, adjusts its own uplink transmit power according to the measured path loss, and transmits predetermined signals to the BTS. Therefore, the BTS can correctly receive the signals transmitted from the MS through uplink.

The P-CCPCH is a kind of reference channel for transmitting BTS information and system information to all MSs in the BTS. The P-CCPCH signals are always transmitted with constant transmit power and the magnitude of the transmit power transmitting the P-CCPCH signals is broadcasted to all MSs in the BTS. Accordingly, the MS can measure path loss from the BTS to the MS by means of the transmit power of the P-CCPCH signals broadcasted from the BTS. When the transmit power is controlled using the open-loop power control scheme, a target SINR is initially determined.

When the closed-loop power control scheme is used, the BTS receives specific channel signals received from an MS, measures the magnitude, i.e., SINR of the received channel signals, and transmits a TPC command representing that increase of transmit power is required to the MS when the SINR of the received channel signals received from the MS is less than a preset threshold value, i.e., a target SINR. However, when the SINR of the received channel signals received from the MS is larger than the threshold value, the BTS transmits a TPC command representing that decrease of transmit power is required to the MS.

The MS adjusts uplink transmit power according to the TPC command received from the BTS, such that the transmit power of the channel signals received in the BTS can have a constant level. According to the closed-loop power control scheme, the MS controls the uplink transmit power based on the TPC command fedback from the BTS.

The closed-loop power control scheme as described above controls transmit power based on the target SINR. However, in a mobile communication system, actual criteria for quality evaluation of radio channel signals may be a Frame Error Rate (FER) rather than the SINR. The FER indicates error rate limitation of digital signals required for providing a service of good quality, and has a close correlation with the communication satisfaction of a user using the service. Accordingly, a target FER has been set in the mobile communication system in order to provide the service of good quality.

When the power control is performed using only the closed-loop power control scheme, an FER larger or smaller than the target FER may be obtained because a measured FER changes due to channel conditions even though it has the same SINR. As a result, the total capacity of the mobile communication system may be inefficiently used. That is, a corresponding relation between the SINR and the FER may irregularly change due to outer factors such as channel conditions and movement speeds of an MS.

Therefore, a power control scheme has been required that enables the target SINR to be used in the closed-loop power control scheme to adapt according to channel conditions, instead of fixing the target SINR to a specific value, thereby maintaining the target FER. This power control scheme is the outer-loop power control scheme. The outer-loop power control scheme adaptively changes the target SINR used in the closed-loop power control scheme according to channel conditions in order to constantly maintain a desired specific performance index, e.g., the target FER.

Herein, when the uplink transit power is controlled using the closed-loop power control scheme, the corresponding performance is ensured only when signals to be transmitted from an MS to a BTS through uplink continuously exist. In addition, as a difference between a reception time point of previously received signals and a reception time point of currently received signals increases due to increase or decrease in transmit power with respect to the SINR of the signals received at the previous time point, the corresponding performance deteriorates. Accordingly, when data having the continuity such as circuit data is transmitted when data having the continuity of circuit-mode such as voice communication, it is preferable to control the uplink transmit power using the closed-loop power control scheme. However, when burst data, such as packet data, is transmitted, controlling the uplink transmit power by means of the open-loop power control scheme is more preferable than controlling the uplink transmit power using the closed-loop power control scheme.

FIG. 3 is a flow diagram illustrating a conventional power control process in the WCDMA-TDD mobile communication system. Referring to FIG. 3, a BTS physical layer 300 transmits BCH signals and P-CCPCH signals to an MS physical layer 310 in step 301. The MS physical layer 310 measures receive power P_{P-CCPCH,RX} of the P-CCPCH signal in step 303. Further, the MS physical layer 310 transfers SI detected from the BCH and the P-CCPCH signals to an MS Radio Resource Control (RRC) layer 320 in step 305.

Before a call is set up, a Radio Bearer (RB) is set up between the BTS and the MS in step 307. Herein, the MS RRC layer 320 detects target SINR SINR_{target} included in a RB setup message received from the BTS in the RB setup process, interference power I_{BTS} of the BTS measured in the BTS, transmit power P_{P-CCPCH,TX} of a P-CCPCH transmitted from the BTS, and a power compensation value DPCH_{const}. Herein, it is assumed that an uplink channel transmitted from the MS is referred to as a Dedicated Physical Channel (DPCH). Accordingly, the power compensation value DPCH_{const} becomes a power compensation value based on the DPCH.

The MS RRC layer 320 initializes a physical layer using the detected target SINR SINR_{target}, interference power IBTS of the BTS, transmit power P_{P-CCPCH,TX} of the P-CCPCH transmitted from the BTS, and power compensation value DPCH_{const} in step 309.

When the call setup is completed using the scheme described above, the MS physical layer 310 transmits a first uplink frame, which is initially transmitted, to the BTS physical layer 300 through the DPCH in step 311. Herein, the first uplink frame is transmitted with transmit power determined by the open-loop power control scheme as described above. The transmit power may be determined as expressed in Equation (1).
P_{DPCH}=α·L_{P-CCPCH}+(1−α)·L₀+I_{BTS}+SINR_{target}+DPCH_{const} (1)

In Equation (1), P_{DPCH} denotes the transmit power of the MS and L_{P-CCPCH} denotes path loss experienced by the P-CCPCH signals. Herein, the path loss L_{PCCPCH} may be calculated as difference between the transmit power of the P-CCPCH signals transmitted from the BTS and the power of the P-CCPCH signals received in the MS, which may be expressed by Equation (2).
L_{P-CCPCH}=P_{P-CCPCH,TX}−P_{P-CCPCH,RX} (2)

The BTS notifies the MS of the transmit power P_{P-CCPCH,TX} of the P-CCPCH through a preset control message, etc., and the MS detects the receive power P_{P-CCPCH,RX} of the P-CCPCH by measuring the power of the P-CCPCH signals received in the MS.

Further, L₀ in Equation (1) denotes an average path loss obtained by averaging the path loss L_{P-CCPCH} during a preset time period. Referring to Equation (1), the total path loss L is defined as a weighted average value of the path loss L_{PCCPCH} and the average path loss L₀, which may be expressed by Equation (3).
L=α·L_{P-CCPCH}+(1−α)·L₀ (3)

In Equation (3), a is a weighted value for controlling the rate at which the path loss L_{PCCPCH} and the average path loss L₀ constituting the total path loss L are applied. If a time slot between uplink and downlink is small, it is necessary to increase a portion of the path loss L_{PCCPCH} in the total path loss L instead of the average path loss L₀ because the channel variation is relatively small. Accordingly, it is preferred to set the weighted value α to a large value.

However, if the time slot between the uplink and the downlink is large, it is necessary to increase a portion of the average path loss L₀ in the total path loss L instead of the path loss L_{PCCPCH} because the channel variation is relatively large. Accordingly, it is preferred to set the weighted value α to a small value.

Further, in Equation (1), I_{BTS} is interference of the BTS measured by the BTS. In the conventional WCDMA-TDD mobile communication system, because uplink signals of all MSs experience the same interference according to each time slot, the BTS interference I_{BTS} is commonly applied to all MSs according to each time slot. Further, the BTS interference I_{BTS} is broadcast to all MSs in the BTS through a broadcast channel, etc. The SINR_{target} is a SINR that each MS targets and the BTS may notify the MS of the target SINR SINR_{target} through a control message, etc., before setting up a DPCH with the MS. Further, the BTS may notify the MS of the SINR_{target} through the control message when the SINR_{target} must change even after setting up the DPCH with the MS. The DPCH_{const} is a power compensation value for power compensation when the uplink power control is controlled using the open-loop power control scheme, which is determined to have a constant value.

When the MS physical layer 310 transmits the first uplink frame through the DPCH with the transmit power determined by the scheme as described above, the BTS physical layer 300 receives the first uplink frame transmitted from the MS physical layer 310, and measures the SINR of the DPCH signals. Further, the BTS physical layer 300 compares the measured SINR of the DPCH signals with the target SINR.

As a result of the comparison, when the measured SINR of the DPCH signals is larger than the target SINR, the BTS physical layer 300 generates a TPC command representing that it is necessary to transmit the DPCH signals with transmit power smaller than current transmit power by a preset step value. However, when the measured SINR of the DPCH signals is less than the target SINR, the BTS physical layer 300 generates a TPC command representing that it is necessary to transmit the DPCH signals with transmit power larger than current transmit power by the preset step value. Herein, the TPC command may be expressed by one bit. When a TPC command bit is 0, the TPC command represents a command for adjusting the transmit power of the DPCH signals to the transmit power smaller than the current transmit power by the preset step value.

However, when the TPC command bit is 1, the TPC command represents a command for adjusting the transmit power of the DPCH signals to the transmit power larger than the current transmit power by the preset step value. Herein, transmit power corresponding to the step value is defined as ΔP, and the TPC command is transmitted through a Dedicated Physical Control Channel (DPCCH). In FIG. 3, it is assumed that the TPC command bit has been set to 1.

The BTS physical layer 300 transmits DPCCH signals having the TPC command bit having been set to 1 to the MS physical layer 310 in step 313. The MS physical layer 310 receives the DPCCH signals and the transmits a second uplink frame with transmit power (P_{DPCH}=P_{DPCH}+ΔP), which is obtained by adding transmit power corresponding to the step value to the previous DPCH transmit power, through the DPCH, because the TPC command bit has been set to 1, in step 315.

As described above, transmit power of DPCH signals transmitting the second uplink frame is controlled by the closed-loop power control scheme.

In a 4^{th} generation (4G) communication system, which is the next generation communication system, research has been actively pursued to provide users with services having various qualities of service (QoSs) at a high speed. Further, a wireless Local Area Network (LAN) system and a wireless Metropolitan Area Network (MAN) system generally support transmission speed of 20 Mbps to 50 Mbps. Accordingly, a current 4G communication system has been developed into a system for ensuring mobility and QoS in the wireless LAN system and the wireless MAN system that support relatively high transmission speed.

The wireless MAN system is a Broadband Wireless Access (BWA) communication system that has a wide service coverage and supports higher transmission speed, as compared with the wireless LAN system. In order to support a broadband transmission network for a physical channel of the wireless MAN system, a system using an Orthogonal Frequency Division Multiplexing (OFDM) scheme/an Orthogonal Frequency Division Multiple Access (OFDMA) scheme is an IEEE (Institute of Electrical and Electronics Engineers) 802.16a communication system. Because the IEEE 802.16a communication system applies the OFDM/OFDMA scheme to the wireless MAN system, it transmits physical channel signals using a plurality of sub-carriers. Therefore, the IEEE 802.16a communication system may transmit data at high speed.

Further, an IEEE 802.16e communication system accommodates the mobility of an MS in the IEEE 802.16a communication system. Both the IEEE 802.16a communication system and the IEEE 802.16e communication system are BWA communication systems using the OFDM/OFDMA scheme. Further, both the IEEE 802.16a communication system and the IEEE 802.16e communication system may use the TDD scheme as a duplexing scheme.

FIG. 4 is a diagram schematically illustrating a conventional frame structure in the IEEE 802.16e communication system. However, before a description on FIG. 4 is given, it is noted that the IEEE 802.16a communication system and the IEEE 802.16e communication system have the same frame structure, but the IEEE 802.16e communication system accommodates the mobility in contrast with the IEEE 802.16a communication system. Therefore, in FIG. 4, for convenience of description, only the frame structure in the IEEE 802.16e communication system will be described.

Referring to FIG. 4, each frame includes a plurality of bursts defined in a time-frequency domain. Each of the bursts is multiple-accessed between a BTS and an MS through a TDMA scheme. Further, a downlink frame and an uplink frame are duplexed through a TDD scheme. Transmission Gaps (TGs) including TTGs and RTGs exist between the downlink frame and the uplink frame.

Each MS performs an initial ranging and a periodic ranging in order to correct time and frequency errors of each burst in the uplink frame and adjust power. When the MS performs the ranging, the BTS measures receive power of signals transmitted from the MS, and notifies the MS of path loss and a compensation value due to the path loss through a preset control message, e.g., a control message of a Medium Access Control (MAC) layer by means of the receive power of the signals transmitted from the MS.

The WCDMA-TDD mobile communication system, the IEEE 802.16a communication system, and the IEEE 802.16e communication system have a number of problems.

First, because the power compensation value of a DPCH changes according to the movement speed of an MS, measurement errors of receive power, etc., the DPCH_{const} must be set according to conditions of each MS. However, the WCDMA-TDD mobile communication system, the IEEE 802.16a communication system, and the IEEE 802.16e communication system have not proposed a detailed consideration for a scheme for setting the power compensation value DPCH_{const} according to the conditions of each MS. Accordingly, because it is impossible to consider the conditions of each MS, i.e., the movement speed, the measurement error, etc., effective transmit power control cannot be performed.

Second, when a communication system employing the TDD scheme as a duplexing scheme uses an uplink receive diversity antenna, one antenna is used for both transmission and reception and another antenna is used only for reception. Consequently, because it is impossible to consider antenna path loss for the antenna used only for the reception, effective transmit power control cannot be performed.

Third, the 4G mobile communication system has actively applied an OFDM/OFDMA scheme to a physical layer as described above, but performance deterioration may occur due to a frequency selective fading when the OFDM/OFDMA scheme is used. Therefore, an Adaptive Modulation and Coding (AMC) scheme has been proposed in order to compensate for the performance deterioration due to the frequency selective fading.

The AMC scheme adaptively adjusts a modulation scheme and a coding scheme, which are allocated to each sub-carrier, according to frequency response characteristics of each sub-carrier. For example, the frequency response may be defined as the SINR. In this case, the modulation scheme and the coding scheme is adaptively adjusted according to SINRs of each sub-carrier.

The AMC scheme includes a plurality of modulation schemes and a plurality of coding schemes, and modulates and codes signals through combinations of the modulation schemes and the coding schemes. Typically, each of the combinations of the modulation schemes and the coding schemes is referred to as a Modulation and Coding Scheme (MCS), and it is possible to define a plurality of MCSs from a level 1 to a level N according to the number of the MCSs. As a result, the AMC scheme adaptively determines the level of the MCS according to frequency response characteristics of a BTS and MSs in order to increase the transmission capacity of the BTS, thereby improving the entire system efficiency.

Herein, because a target SINR based on the level of the MCS is differently set according to the frequency selectivity of a channel and the interference distribution on a frequency axis, the power compensation value DPCH_{const} must also be adjusted according to the frequency selectivity of the channel and the interference distribution on the frequency axis. However, because the WCDMA-TDD mobile communication system, the IEEE 802.16a communication system, and the IEEE 802.16e communication system have not proposed a detailed consideration for a scheme for adjusting the power compensation value DPCH_{const} according to the frequency selectivity of the channel and the interference distribution on the frequency axis, effective transmit power control cannot be performed.

Fourth, because the WCDMA-TDD mobile communication system, the IEEE 802.16a and the IEEE 802.16e communication system have not proposed a detailed consideration for a scheme for updating the power compensation value DPCH_{const}, effective transmit power control cannot be performed.

### SUMMARY OF THE INVENTION

Accordingly, the present invention has been designed to solve the above and other problems occurring in the prior art. It is an object of the present invention to provide an apparatus and a method for controlling uplink power utilizing an open-loop scheme in a mobile communication system using a TDD scheme.

It is another object of the present invention to provide an apparatus and a method for controlling power utilizing an open-loop scheme, which feedbacks a power compensation value due to packet error occurrence in a mobile communication system using a TDD scheme.

In accordance with an aspect of the present invention, there is provided an apparatus for controlling uplink transmit power by an Access Terminal (AT) in a mobile communication system using a Time Division Duplexing (TDD) scheme. The apparatus includes: a transmitter for transmitting uplink signals to an Access Point (AP) using initial uplink transmit power determined by a predetermined control, and transmitting uplink signals to the AP utilizing uplink transmit power adjusted by a predetermined control; a receiver for receiving downlink signals from the AP and detecting a power compensation value for compensating for the uplink transmit power, the power compensation value being determined according to whether an error has occurred in the uplink signals; and a transmit power controller for determining the initial uplink transmit power, and controlling the uplink transmit power to be adjusted according to receive power and the power compensation value.

In accordance with another aspect of the present invention, there is provided an apparatus for controlling uplink transmit power of an Access Terminal (AT) by an Access Point (AP) in a mobile communication system using a Time Division Duplexing (TDD) scheme. The apparatus includes: a transmitter for transmitting downlink signals including parameters required for determining an initial value of the uplink transmit power of an AT, and transmitting downlink signals including a power compensation value for compensating for the uplink transmit power determined by a predetermined control; a receiver for receiving uplink signals from the AT, and detecting if an error has occurred in the uplink signals; and a power compensation value calculator for determining the power compensation value for compensating for the uplink transmit power according to whether the error has occurred in the uplink signals.

In accordance with another aspect of the present invention, there is provided a method for controlling uplink transmit power by an Access Terminal (AT) in a mobile communication system using a Time Division Duplexing (TDD) scheme. The method including the steps of: determining initial uplink transmit power; transmitting uplink signals to an Access Point (AP) utilizing the determined initial uplink transmit power; receiving downlink signals from the AP; measuring receive power of the received downlink signals; detecting a power compensation value from the received downlink signals in order to compensate for the uplink transmit power, the power compensation value being determined according to whether an error has occurred in the uplink signals; adjusting the uplink transmit power according to the measured receive power and the detected power compensation value.

In accordance with still another aspect of the present invention, there is provided a method for controlling uplink transmit power of an Access Terminal (AT) by an Access Point (AP) in a mobile communication system using a Time Division Duplexing (TDD) scheme. The method includes the steps of: transmitting downlink signals including parameters required for determining an initial value of the uplink transmit power of an AT; when uplink signals are received from the AT, detecting if an error has occurred in the uplink signals; determining a power compensation value for compensating for the uplink transmit power according to whether the error has occurred in the uplink signals; and transmitting downlink signals including the power compensation value.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram schematically illustrating a conventional WCDMA-TDD mobile communication system;

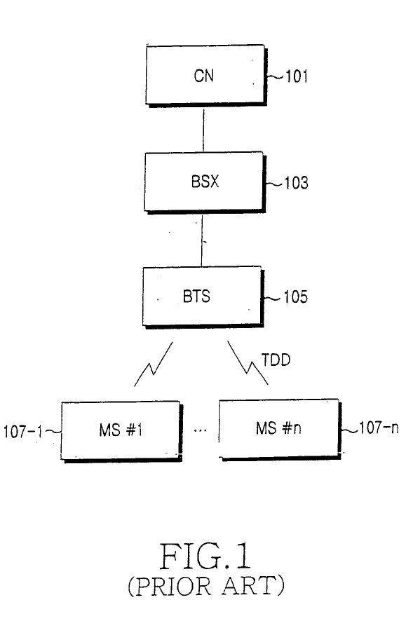

FIG. 2 is a diagram schematically illustrating an uplink and a downlink frame in a conventional WCDMA-TDD mobile communication system;

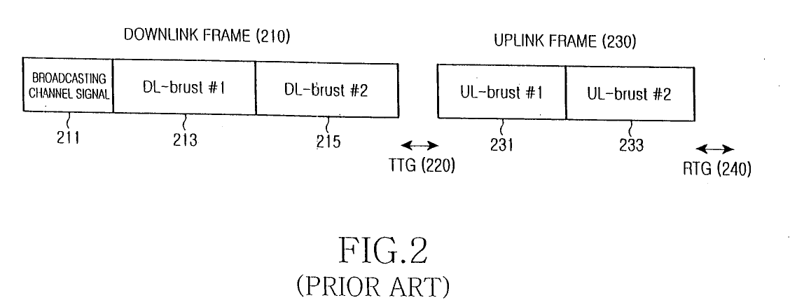

FIG. 3 is a flow diagram illustrating a conventional power control process in a WCDMA-TDD mobile communication system;

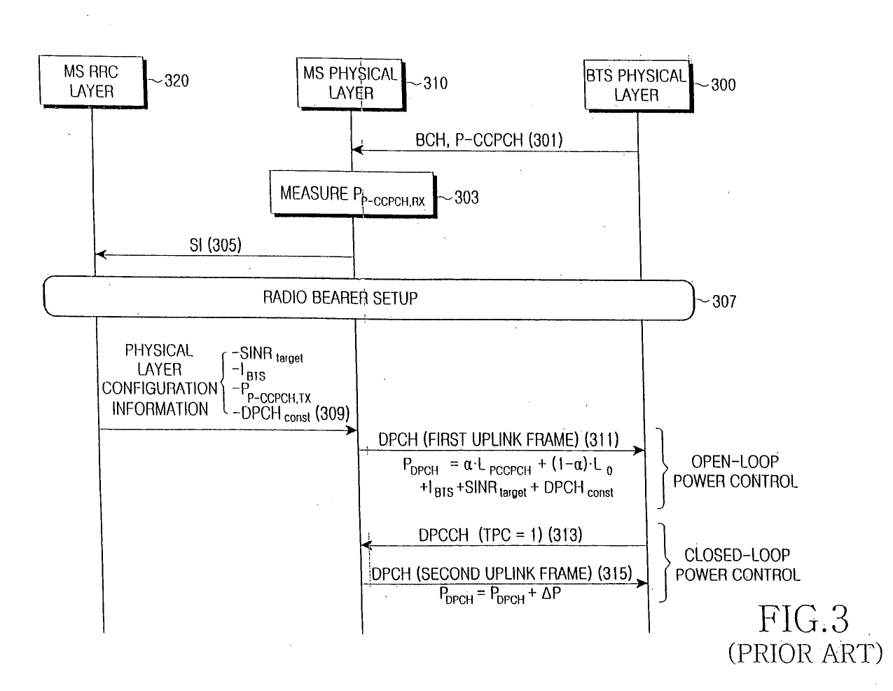

FIG. 4 is a diagram schematically illustrating a conventional frame structure in an IEEE 802.16e communication system;

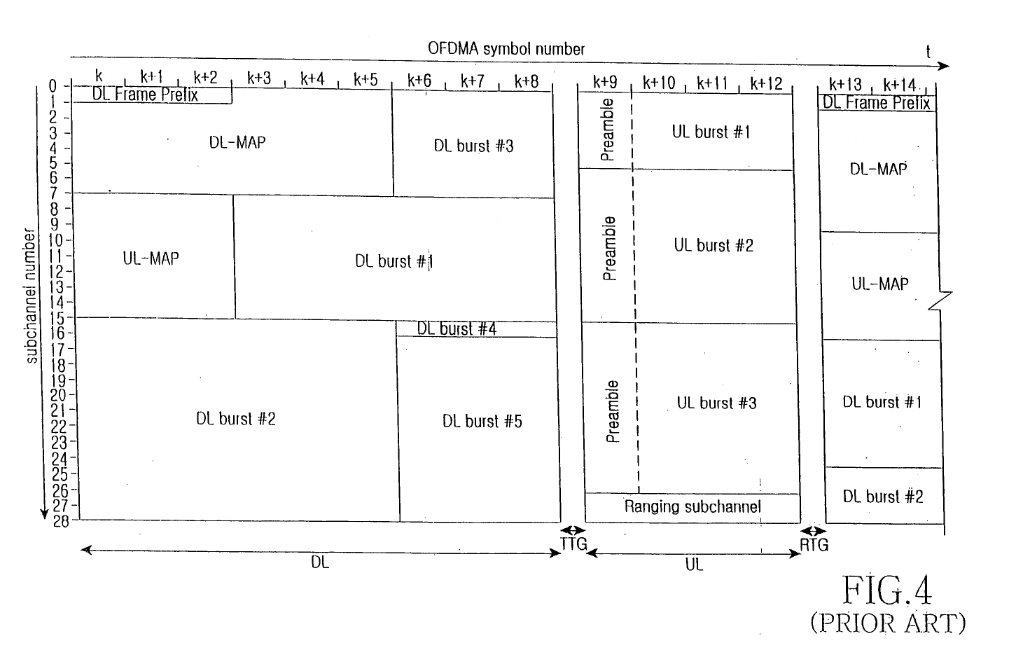

FIG. 5 is a block diagram schematically illustrating an AT in an IEEE 802.16e communication system according to an embodiment of the present invention;

FIG. 6 is a flow diagram schematically illustrating an uplink open-loop transmit power control operation of the AT in an IEEE 802.16e communication system according to an embodiment of the present invention;

FIG. 7 is a block diagram schematically an AP in an IEEE 802.16e communication system according to an embodiment of the present invention;

FIG. 8 is a flow diagram schematically illustrating an uplink open-loop transmit power control operation of an AP in an IEEE 802.16e communication system according to an embodiment of the present invention;

FIG. 9 is a block diagram schematically illustrating an AT in an IEEE 802.16e communication system according to an embodiment of the present invention;

FIG. 10 is a flow diagram schematically illustrating an uplink open-loop transmit power control operation of the AT in an IEEE 802.16e communication system according to an embodiment of the present invention;

FIG. 11 is a block diagram schematically illustrating an AP in an IEEE 802.16e communication system according to an embodiment of the present invention; and

FIG. 12 is a flow diagram schematically illustrating an uplink open-loop transmit power control operation of an AP in an IEEE 802.16e communication system according to an embodiment of the present invention.

### DETAILED DESCRIPTION OF THE PREFERRED EMBODIMENT

Hereinafter, preferred embodiments according to the present invention will be described with reference to the accompanying drawings. In the following description of the present invention, a detailed description of known functions and configuration incorporated herein will be omitted when it may obscure the subject matter of the present invention.

The present invention proposes a scheme for controlling uplink power utilizing an open-loop scheme in a mobile communication system using a Time Division Duplexing (TDD) scheme (TDD mobile communication system). More specifically, the present invention proposes a power control method of an open-loop scheme, in which an Access Point (AP) feedbacks a power compensation value for uplink transmit power of an Access Terminal (AT) according to whether an error has occurred in packet data transmitted from the AT through uplink. For convenience of description, an open-loop power control method of the present invention will be described as an IEEE (Institute of Electrical and Electronics Engineers) 802.16e communication system, which uses the TDD scheme as a duplexing scheme, as an example. However, the open-loop power control method proposed by the present invention can be applied to all communication systems using the TDD scheme as the duplexing scheme.

Further, a downlink power control denotes a power control for signals transmitted from a transmission side to a reception side, and an uplink power control denotes a power control for signals transmitted from the reception side to the transmission side. For convenience of description, it is assumed that the transmission side corresponds to an AP and the reception side corresponds to an AT.

Because the IEEE 802.16e communication system uses the TDD scheme as the duplexing scheme, it may be assumed that downlink and uplink channel environments are nearly identical.

In a 4^{th} generation (4G) communication system, which is the next generation communication system, research has been actively pursued to provide users with services having various qualities of service (QoSs) at a high speed. More specifically, research has been actively pursued to transmit mass storage packet data at a high speed. One of the various schemes for transmitting the mass storage packet data at the high speed is the power control method, and uplink transmit power based on the open-loop power control method proposed by the present invention may be expressed by Equation (4).
P_{UL,TX}=SINR_{target}+I_{AP}+α·PathLossᵢₙₛₜ+(1−α)·PathLoss_{avg}+Offset_{perAT} (4)

In Equation (4), P_{UL,TX} denotes uplink transmit power, SINR_{target} denotes a target Signal-to-Interference Noise Ratio (SINR), I_{AP} denotes interference of an AP measured in the AP, PathLossᵢₙₛₜ denotes path loss at a current time point, i.e., instantaneous path loss, PathLoss_{avg} denotes an average path loss obtained by averaging path loss during a preset setting time period, α denotes a weighted value for controlling the rate at which the instantaneous path loss PathLossᵢₙₛₜ and the average path loss PathLoss_{avg} constituting a total path loss PathLossₜₒₜₐₗ are applied, and Offset_{perAT} denotes a power compensation value. The power compensation value Offset_{perAT} denotes a value determined according to channel conditions of an AT, a value newly proposed by the open-loop power control method of the present invention, and a value fedback from an AP according to whether an error has occurred in packet data transmitted from the AT through uplink. Because this power compensation value Offset_{perAT} will be described later, a detailed description will be omitted here.

If a time slot between uplink and downlink is small, it is necessary to increase a portion of the instantaneous path loss PathLossᵢₙₛₜ in the total path loss PathLossₜₒₜₐₗ instead of the average path loss PathLoss_{avg} because channel variation is relatively small. Accordingly, it is preferable to set the weighted value α to a large value.

However, if the time slot between the uplink and the downlink is large, it is necessary to increase a portion of the average path loss PathLoss_{avg} in the total path loss PathLossₜₒₜₐₗ instead of the instantaneous path loss PathLossᵢₙₛₜ because the channel variation is relatively large. Accordingly, it is preferable to set the weighted value α to a small value.

Herein, the total path loss PathLossₜₒₜₐₗ is calculated by a difference between transmit power of reference channel signals, e.g., pilot channel signals, which have been transmitted from the AP, and power of the reference channel signals received in the AT, which may be expressed by Equation (5).
PathLossₜₒₜₐₗ=α·PathLossᵢₙₛₜ+(1−α)·PathLoss_{avg}=P_{DL,TX}−α·P_{DL,RX,inst}−(1−α)·P_{DL,RX,avg} (5)

In Equation (5), P_{DL,TX} denotes downlink transmit power, P_{DL,TX,inst} denotes receive power of downlink signals at a current time point, i.e., instantaneous downlink receive power, and P_{DL,RX,avg} denotes average receive power of the downlink signals obtained by averaging the receive power during a preset setting time period, i.e., average downlink receive power. The downlink transmit power P_{DL,TX} denotes the transmit power of the reference channel signals, and the AP broadcasts the downlink transmit power P_{DL,TX} to all ATs in a service coverage of the AP through a broadcast channel, etc.

When Equation (5) is applied to Equation (4), the downlink transmit power P_{DL,TX} may be expressed by Equation (6).
P_{UL,TX}=SINR_{target}+I_{AP}+P_{DL,TX}−α·P_{DL,RX,inst}−(1−α)·P_{DL,RX,avg}+Offset_{perAT} (6)

As a result, the open-loop power control method proposed by the present invention determines the uplink transmit power of the AT by the scheme as expressed in Equation (6), and the AP determines the power compensation value Offset_{perAT} according to channel conditions of each AT and feedbacks the determined value to each AT.

Hereinafter, a process in which the AP feedbacks the power compensation value Offset_{perAT} to the AT will be described.

The AP determines an initial value of the power compensation value Offset_{perAT} as a value Offset_{perAT,init}, and broadcasts the initial power compensation value Offset_{perAT,init} to all ATs in the service coverage of the AP through the broadcast channel, etc. The power compensation value Offset_{perAT} of each AT is determined according to whether an error has occurred in packet data transmitted from each AT through uplink. The AP transmits the determined power compensation value Offset_{perAT} to each AT.

The AP determines the power compensation value Offset_{perAT} according to whether the error has occurred in all packet data transmitted from each AT through the uplink, but it does not transmit all power compensation values Offset_{perAT} determined for each packet data to the AT. Further, the AP transmits the power compensation values Offset_{perAT} to the AT every a preset period PERIOD_OFFSET_MSG during signal transmission/reception with the AT, or transmits the power compensation values Offset_{perAT} when a power compensation values Offset_{perAT} transmitted in the previous period exceeds a preset threshold value X [dB] even through the period PERIOD_OFFSET_MSG has not arrived. Herein, the AP may transmit all power compensation values Offset_{perAT} determined for each packet data to the AT. However, this may increase signaling load. Accordingly, the AP transmits the power compensation values Offset_{perAT} every the period PERIOD_OFFSET_MSG or only in the case of exceeding the threshold value X [dB].

Because the power compensation value Offset_{perAT} is updated within the period PERIOD_OFFSET_MSG as described above, it must be determined by only values between a lower bound value Offset_BoundLower and an upper bound value Offset_BoundUpper. That is, even though the power compensation value Offset_{perAT} is updated less than the lower bound value Offset_BoundLower, the power compensation value Offset_{perAT} is finally determined to be the lower bound value Offset_BoundLower.

Further, even though the power compensation value Offset_{perAT} is updated exceeding the upper bound value_Offset_BoundUpper, the power compensation value Offset_{perAT} is finally determined to be the upper bound value Offset_BoundUpper.

Hereinafter, a process in which the AP determines the power compensation value Offset_{perAT} according to whether the error has occurred in the packet data transmitted from the AT through the uplink will be described.

When the error has not occurred in the packet data transmitted from the AT through the uplink, the AP determines that channel conditions of the AT are relatively favorable, determines the power compensation value Offset_{perAT} as a value obtained by subtracting a value, which has reflected a preset step value by a preset ratio (i.e.,

$$( i . e . , \frac{1}{\frac{1}{{FER}_{target}} - 1} ) ,$$

from a power compensation value Offset_{perAT} at a current time point, and feeds back the determined power compensation value Offset_{perAT} to the AT. The preset step value will be referred to as an UP_STEP.

However, When the error has occurred in the packet data transmitted from the AT through the uplink, the AP determines that channel conditions of the AT are relatively unfavorable, determines the power compensation value Offset_{perAT} as a value obtained by adding the preset step value to the power compensation value Offset_{perAT} at the current time point, and feeds back the determined power compensation value Offset_{perAT} to the AT.

In situations other than these two cases, the power compensation value Offset_{perAT} is maintained the power compensation value Offset_{perAT} at the current time point. The operation process in which the AP determines the power compensation value Offset_{perAT} may be expressed by Equation (7).

$$\begin{matrix}{Offset}_{perAT} = {Offset}_{perAT} + UP\_STEP & if Error is detected \\ {Offset}_{perAT} = {Offset}_{perAT} - \frac{1}{1 / {FER}_{target} - 1} UP\_STEP & else if Error is not detected\end{matrix} \\ \begin{matrix}{Offset}_{perAT} = {Offset}_{perAT} & else where\end{matrix} \qquad ( 7 )$$

In Equation (7), FER_{target} denotes a target Frame Error Rate (FER).

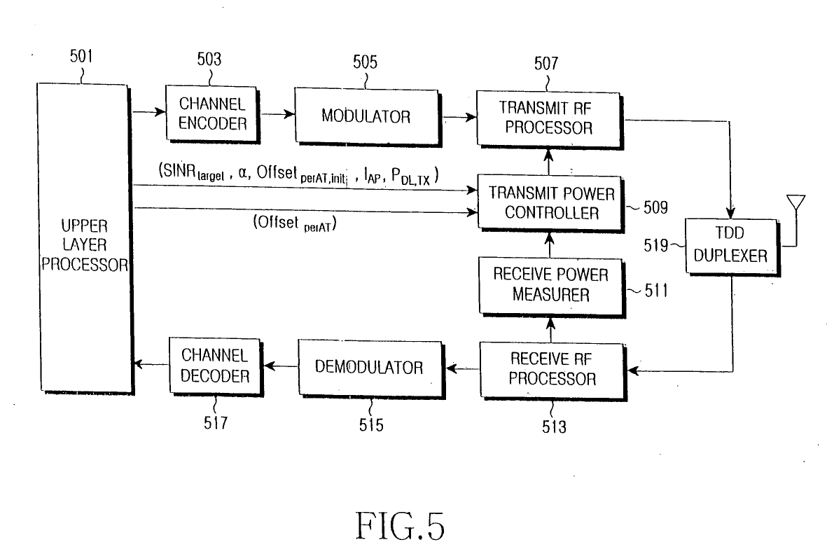

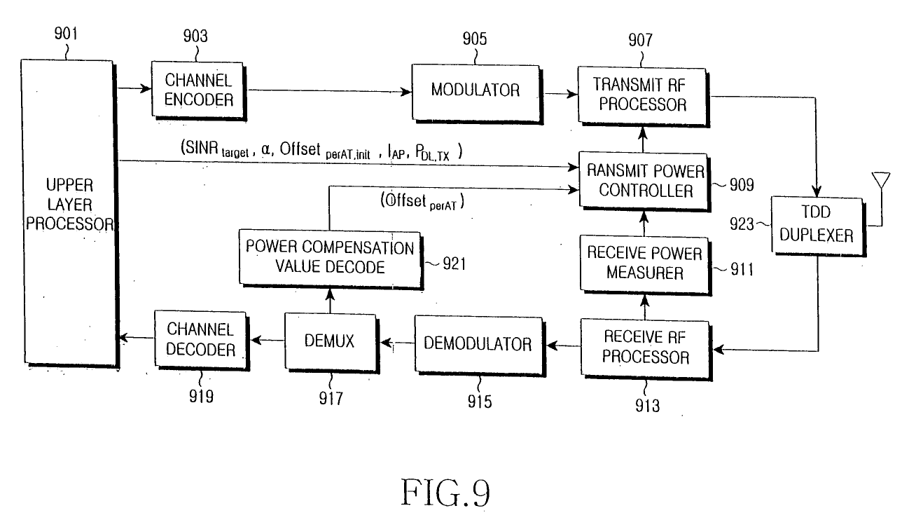

Hereinafter, the open-loop power control method according to an embodiment of the present invention will be described with reference to FIGS. 5 to 8, and the open-loop power control method according to another embodiment of the present invention will be described with reference to FIGS. 9 to 12. In the first embodiment of the present invention, the power compensation value Offset_{perAT} is provided through a control message, such that an open-loop power control is performed. In the second embodiment of the present invention, the power compensation value Offset_{perAT} is provided through a physical channel, so that the open-loop power control is performed. In the first and the second embodiment of the present invention, actual open-loop power control methods are identical and there is only a difference according to whether the power compensation value is provided through the control message or the physical channel.

FIG. 5 is a block diagram schematically illustrating an AT in the IEEE 802.16e communication system according to a first embodiment of the present invention. Referring to FIG. 5, the AT includes an upper layer processor 501, a channel encoder 503, a modulator 505, a transmit Radio Frequency (RF) processor 507, a transmit power controller 509, a receive power measurer 511, a receive RF processor 513, a demodulator 515, a channel decoder 517, and a TDD duplexer 519.

The upper layer processor 501 detects packet data to be transmitted to an AP and outputs the packet data to the channel encoder 503. The channel encoder 503 encodes the packet data by a preset encoding scheme and outputs the encoded packet data to the modulator 505. The encoding scheme may be a turbo encoding scheme having a predetermined coding rate, a convolutional encoding scheme, etc.

The modulator 505 inputs the signals output from the channel encoder 503, modulates the signals by a preset modulation scheme, and outputs the modulated signals to the transmit RF processor 507. The modulation scheme may be a Quadrature Phase shift Keying (QPSK) scheme, 16 Quadrature Amplitude Modulation (QAM) scheme, etc. The transmit RF processor 507 includes a filter, a front end unit, etc., inputs the signals output from the modulator 505, RF-processes the signals so that the signals can be transmitted to the air, and outputs the processed signals to the TDD duplexer 519.

The TDD duplexer 519 transmits the signals output from the transmit RF processor 507 to the air through an antenna in a corresponding time slot. Further, the TDD duplexer 519 outputs signals received through the antenna to the receive RF processor 513.

The receive RF processor 513 includes a filter, a front end unit, etc., converts the signals output from the TDD duplexer 519 into baseband signals, and outputs the baseband signals to the receive power measurer 511 and the demodulator 515. The receive power measurer 511 inputs the signals output from the receive RF processor 513, measures instantaneous downlink receive power P_{DL,TX,inst} and average downlink receive power P_{DL,RX,avg}, and outputs the measured receive power to the transmit power controller 509.

The demodulator 515 inputs the signals output from the receive RF processor 513, demodulates the signals by a demodulation scheme corresponding to a modulation scheme used by the AP, and outputs the demodulated signals to the channel decoder 517. The channel decoder 517 inputs the signals output from the demodulator 515, decodes the signals by a decoding scheme corresponding to an encoding scheme employed by the AP, and outputs the decoded signals to the upper layer processor 501.

The upper layer processor 501 receives a control message transmitted from an upper layer of the AP, and detects parameters for controlling uplink transmit power, which are included in the control message. The parameters for controlling the uplink transmit power includes the target SINR SINR_{target}, the weighted value α, the initial power compensation value Offset_{perAT,init}, the AP interference I_{AP}, the downlink transmit power P_{DL,TX}, and the power compensation value Offset_{perAT}. Because the first embodiment of the present invention relates to a case where the power compensation value Offset_{perAT} is transmitted through the control message, the upper layer processor 501 receives the control message from an upper layer processor of the AP, and detects the power compensation value Offset_{perAT}.

The upper layer processor 501 outputs the detected target SINR SINR_{target}, weighted value α, initial power compensation value Offset_{perAT,init}, AP interference I_{AP}, downlink transmit power P_{DL,TX}, and power compensation value Offset_{perAT} to the transmit power controller 509. The transmit power controller 509 determines uplink transmit power P_{UL,TX} of the AT by means of the received target SINR SINR_{target}, weighted value α, initial power compensation value Offset_{perAT,init}, AP interference I_{AP}, downlink transmit power P_{DL,TX}, and power compensation value Offset_{perAT} and controls the transmit RF processor 507 to adjust uplink transmit power according to the determined uplink transmit power P_{UL,TX}. Because the uplink transmit power P_{UL,TX} is determined by the scheme as described above with Equation (6), a detailed description will be omitted here.

It is noted that FIG. 5 does not illustrate the construction of a separated element, i.e., a Fast Fourier Transform (FFT) and an Inverse Fast Fourier Transform (IFFT), for application of the OFDM scheme and the OFDMA scheme.

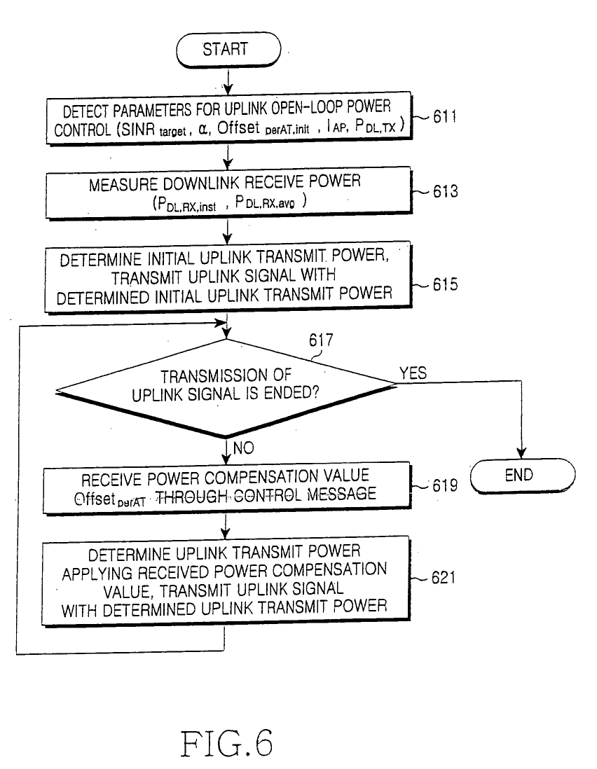

FIG. 6 is a flow diagram schematically illustrating an uplink open-loop transmit power control operation of the AT in the IEEE 802.16e communication system according to the first embodiment of the present invention. The uplink open-loop transmit power control operation of the AT described in FIG. 6 corresponds to an uplink open-loop transmit power control operation after uplink and downlink channel setup is completed.

Referring to FIG. 6, in step 611, the AT detects the parameters for uplink open-loop transmit power control, i.e., the target SINR SINR_{target}, the weighted value α, the initial power compensation value Offset_{perAT,init}, the AP interference I_{AP}, and the downlink transmit power P_{DL,TX}. In step 613, the AT measures the downlink receive power, i.e., the instantaneous downlink receive power P_{DL,TX,inst} and the average downlink receive power P_{DL,RX,avg}.

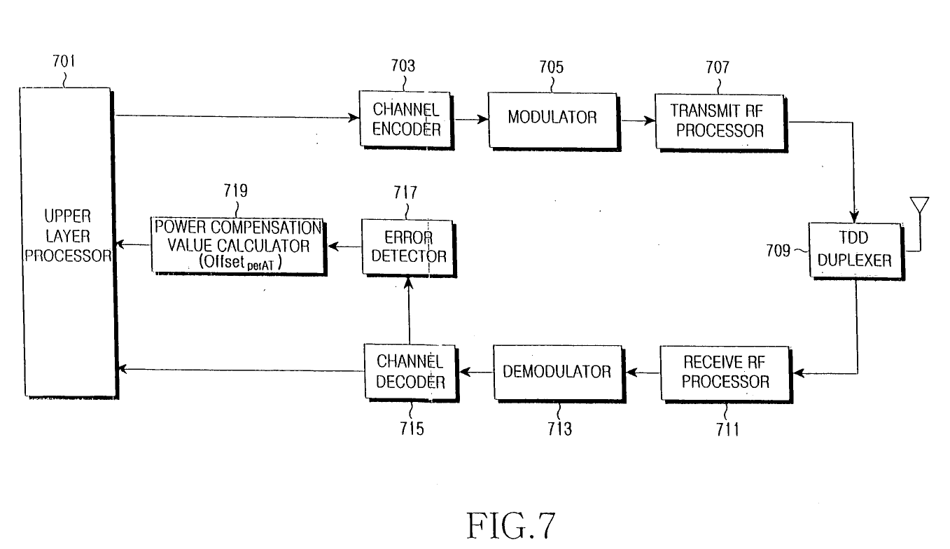

In step 615, the AT determines initial uplink transmit power by means of the detected target SINR SINR_{target}, weighted value α, initial power compensation value Offset_{perAT,init}, AP interference I_{AP}, downlink transmit power P_{DL,TX}, and transmits uplink signals by means of the determined initial uplink transmit power. The initial uplink transmit power is determined by applying the power compensation value as will described in FIG. 7 to the initial power compensation value Offset_{perAT,init}.

In step 617, the AT determines if transmission of the uplink signals has been ended. When the transmission of the uplink signals has not ended, in step 619, the AT receives the power compensation value Offset_{perAT} through the control message from the AP. In step 621, the AT determines the uplink transmit power by applying the received power compensation value Offset_{perAT}, and transmits uplink signals with the determined transmit power. Thereafter, the procedure returns to step 617.

The uplink transmit power is determined by applying the power compensation value as will be described in FIG. 7 to the received power compensation value Offset_{perAT}.

FIG. 7 is a block diagram schematically illustrating the AP in the IEEE 802.16e communication system according to the first embodiment of the present invention. Referring to FIG. 7, the AP includes an upper layer processor 701, a channel encoder 703, a modulator 705, a transmit RF processor 707, a TDD duplexer 709, a receive RF processor 711, a demodulator 713, a channel decoder 715, an error detector 717, and a power compensation value calculator 719.

The upper layer processor 701 detects a control message to be transmitted to an AT and outputs the control message to the channel encoder 703. The control message includes parameters for uplink open-loop transmit power control of the AT, i.e., the target SINR SINR_{target}, the weighted value α, the initial power compensation value Offset_{perAT,init}, the AP interference I_{AP}, the downlink transmit power P_{DL,TX}, and the power compensation value Offset_{perAT}.

The channel encoder 703 encodes the control message by a preset encoding scheme and outputs the encoded control message to the modulator 705. The encoding scheme may be a turbo encoding scheme having a predetermined coding rate, a convolutional encoding scheme, etc. The modulator 705 inputs the signals output from the channel encoder 703, modulates the signals by a preset modulation scheme, and outputs the modulated signals to the transmit RF processor 707. The modulation scheme may be a QPSK scheme, 16 QAM scheme, etc. The transmit RF processor 707 includes a filter, a front end unit, etc., inputs the signals output from the modulator 705, RF-processes the signals so that the signals can be transmitted to the air, and outputs the processed signals to the TDD duplexer 709.

The TDD duplexer 709 transmits the signals output from the transmit RF processor 707 to the air through an antenna in a corresponding time slot. Further, the TDD duplexer 709 outputs signals received through the antenna to the receive RF processor 711. The receive RF processor 711 includes a filter, a front end unit, etc., converts the signals output from the TDD duplexer 709 into baseband signals, and outputs the baseband signals to the demodulator 713. The demodulator 713 inputs the signals output from the receive RF processor 711, demodulates the signals by a demodulation scheme corresponding to the modulation scheme employed by the AT, and outputs the demodulated signals to the channel decoder 715. The channel decoder 715 inputs the signals output from the demodulator 713, decodes the signals by a decoding scheme corresponding to the encoding scheme employed by the AT, and outputs the decoded signals to the upper layer processor 701 and the error detector 717.

The error detector 717 detects if an error has occurred in the signals output from the channel decoder 715, i.e., the packet data transmitted from the AT, and outputs the detection result to the power compensation value calculator 719. The power compensation value calculator 719 calculates the power compensation value Offset_{perAT} according to the detection result output from the error detector 717, and outputs the power compensation value Offset_{perAT} to the upper layer processor 701. Because the power compensation value Offset_{perAT} is calculated using Equation (7), a detailed description thereof will be omitted here.

The upper layer processor 701 inserts the power compensation value Offset_{perAT} output from the power compensation value calculator 719 into the control message, and transmits the control message to a corresponding AT. However, it is noted that FIG. 7 does not show the construction of a separated element, i.e., a FFT and an IFFT, for application of the OFDM scheme and the OFDMA scheme.

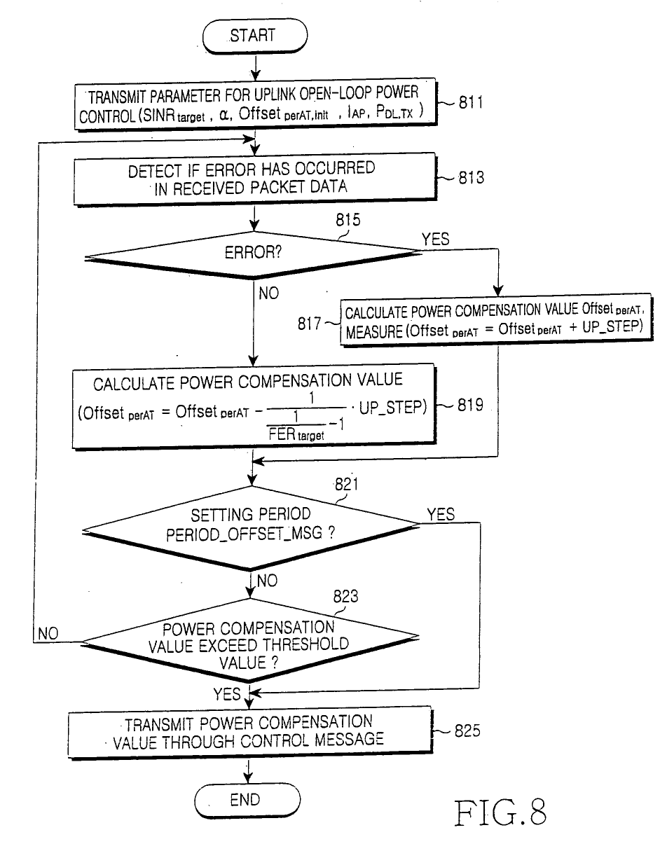

FIG. 8 is a flow chart schematically illustrating an uplink open-loop transmit power control operation of the AP in the IEEE 802.16e communication system according to the first embodiment of the present invention. The uplink open-loop transmit power control operation of the AP described in FIG. 8 corresponds to an uplink open-loop transmit power control operation after uplink and downlink channel setup is completed.

Referring to FIG. 8, in step 811, the AP transmits the parameters for uplink open-loop power control of the AT, i.e., the target SINR SINR_{target}, the weighted value α, the initial power compensation value Offset_{perAT,init}, the AP interference I_{AP}, and the downlink transmit power P_{DL,TX}, and receives packet data from the AT. In step 813, the AP detects if an error has occurred in the packet data received from the AT.

In FIG. 8, a process will be described, in which the AP controls uplink open-loop transmit power of one AT, e.g., an n^{th} random AT. However, the uplink open-loop transmit power control operation as described in FIG. 8 can be performed for all ATs existing in the service coverage of the AP.

In step 815, the AP determines if an error has occurred in the packet data received from the AT. When the error has occurred in the received packet data, in step 817, the AP calculates the power compensation value Offset_{perAT} as a sum of a power compensation value Offset_{perAT} at a current time point and a step value UP_STEP, as described in Equation (7). However, when the error has not occurred in the received packet data, in step 819, the AP calculates the power compensation value Offset_{perAT} as a value obtained by subtracting a multiplication result of the step value

$$UP\_STEP and \frac{1}{\frac{1}{{FER}_{target}} - 1}$$

from the power compensation value
Offset_{perAT} at a current time point, as described in Equation (7)

$$( {Offset}_{perAT} = {Offset}_{perAT} - \frac{1}{\frac{1}{{FER}_{target}} - 1} \cdot UP\_STEP ) .$$

As described above, in calculating the power compensation value Offset_{perAT} in steps 817 and 819, when the power compensation value Offset_{perAT} is calculated as a value less than the lower bound value Offset_BoundLower, the AP determines the power compensation value Offset_{perAT} as the lower bound value Offset_BoundLower. However, when the power compensation value Offset_{perAT} is calculated as a value exceeding the upper bound value Offset_BoundUpper, the AP determines the power compensation value Offset_{perAT} as the upper bound value Offset_BoundUpper.

In step 821, the AP determines if the setting period PERIOD_OFFSET_MSG, in which when the power compensation value Offset_{perAT} is to be fedback to the AT, has arrived. When the setting period PERIOD_OFFSET_MSG has arrived, step 825 is performed. However, when the setting period PERIOD_OFFSET_MSG has not arrived, step 823 is performed.

In step 823, the AP determines if the power compensation value Offset_{perAT} exceeds the preset threshold value X [dB]. When the power compensation value Offset_{perAT} does not exceed the preset threshold value X [dB], the procedure returns to step 813. However, when the power compensation value Offset_{perAT} exceeds the preset threshold value X [dB], step 825 is performed.

In step 825, the AP transmits the power compensation value Offset_{perAT} through the control message. Thereafter, the procedure ends.

FIG. 8 illustrates a case in which the calculated power compensation value Offset_{perAT} is transmitted to the AT through the control message, and a UL_MAP message, etc., may be used as the control message in the IEEE 802.16e communication system. Further, it is possible to define the power compensation value Offset_{perAT} as a new power compensation value Offset_{perAT} \overline{OffsetperAT} obtained by adding a power compensation value Offset_{perAT} to a target SINR, i.e., SINR_{target}, which may be expressed by using Equation (8).
\overline{Offset_{perAT}}=Offset_{perAT}+SINR_{target} (8)

Accordingly, the uplink transmit power P_{UL,TX} of the AT must also change according to the new power compensation value Offset_{perAT} \overline{OffsetperAT} as expressed by Equation (9).
P_{UL,TX}=I_{AP}+P_{DL,TX}−α P_{DL,RX,inst}−(1−α)·P_{DL,RX,avg}+\overline{Offset_{perAT}}
(9)

FIG. 9 is a block diagram schematically illustrating an AT in an IEEE 802.16e communication system according to a second embodiment of the present invention. Referring to FIG. 9, the AT includes an upper layer processor 901, a channel encoder 903, a modulator 905, a transmit RF processor 907, a transmit power controller 909, a receive power measurer 911, a receive RF processor 913, a demodulator 915, a demultiplexer (DEMUX) 917, a channel decoder 919, a power compensation value decoder 921, and a TDD duplexer 923.

The upper layer processor 901 detects packet data to be transmitted to an AP and outputs the packet data to the channel encoder 903. The channel encoder 903 encodes the packet data by a preset encoding scheme and outputs the encoded packet data to the modulator 905. The encoding scheme may be a turbo encoding scheme having a predetermined coding rate, a convolutional encoding scheme, etc. The modulator 905 inputs the signals output from the channel encoder 903, modulates the signals by a preset modulation scheme, and outputs the modulated signals to the transmit RF processor 907. The modulation scheme may be a QPSK scheme, 16 QAM scheme, etc.

The transmit RF processor 907 includes a filter, a front end unit, etc., inputs the signals output from the modulator 905, RF-processes the signals so that the signals can be transmitted to the air, and outputs the processed signals to the TDD duplexer 923. The TDD duplexer 923 transmits the signals output from the transmit RF processor 907 to the air through an antenna in a corresponding time slot. Further, the TDD duplexer 923 outputs signals received through the antenna to the receive RF processor 913.

The receive RF processor 913 includes a filter, a front end unit, etc., converts the signals output from the TDD duplexer 923 into baseband signals, and outputs the baseband signals to the receive power measurer 911 and the demodulator 915. The receive power measurer 911 inputs the signals output from the receive RF processor 913, measures instantaneous downlink receive power P_{DL,TX}, inst and average downlink receive power P_{DL,RX,avg}, and outputs the measured receive power to the transmit power controller 909.

The demodulator 915 inputs the signals output from the receive RF processor 913, demodulates the signals by a demodulation scheme corresponding to a modulation scheme employed by the AP, and outputs the demodulated signals to the DEMUX 917. The DEMUX 917 demultiplexes the signals output from the demodulator 915, outputs dedicated channel (power compensation value channel) signals including a power compensation value Offset_{perAT} to the power compensation value decoder 921, and outputs signals other than the power compensation value channel signals to the channel decoder 919.

The channel decoder 919 inputs the signals output from the DEMUX 917, decodes the signals by a decoding scheme corresponding to an encoding scheme employed by the AP, and outputs the decoded signals to the upper layer processor 901. The power compensation value decoder 921 inputs the signals output from the DEMUX 917, detects the power compensation value Offset_{perAT} transmitted from the AP, and outputs the detected power compensation value Offset_{perAT} to the transmit power controller 909.

The upper layer processor 901 receives a control message transmitted from an upper layer of the AP, and detects parameters for controlling uplink transmit power, which are included in the control message. The parameters for controlling the uplink transmit power includes the target SINR SINR_{target}, the weighted value α, the initial power compensation value Offset_{perAT,init}, the AP interference I_{AP}, and the downlink transmit power P_{DL,TX}, as described above. Because the second embodiment of the present invention relates to a case in which the power compensation value Offset_{perAT} is transmitted through the power compensation value channel, the power compensation value Offset_{perAT} is detected by the power compensation value decoder 921.

The upper layer processor 901 outputs the detected target SINR SINR_{target}, weighted value α, initial power compensation value Offset_{perAT,init}, AP interference I_{AP}, and downlink transmit power P_{DL,TX} to the transmit power controller 909. The transmit power controller 909 determines uplink transmit power P_{UL,TX} of the AT using the target SINR SINR_{target}, the weighted value α, the initial power compensation value Offset_{perAT,init}, the AP interference I_{AP}, and the downlink transmit power P_{DL,TX}, which are output from the upper layer processor 901, and the power compensation value Offset_{perAT} output from the power compensation value decoder 921, and controls the transmit RF processor 907 to adjust uplink transmit power according to the determined uplink transmit power P_{UL,TX}. Because the uplink transmit power P_{UL,TX} is determined by the scheme as described in Equation (6), a detailed description will be omitted here.

It is noted that FIG. 9 does not illustrate the construction of a separated element, i.e., a FFT and an IFFT, for application of the OFDM scheme and the OFDMA scheme.

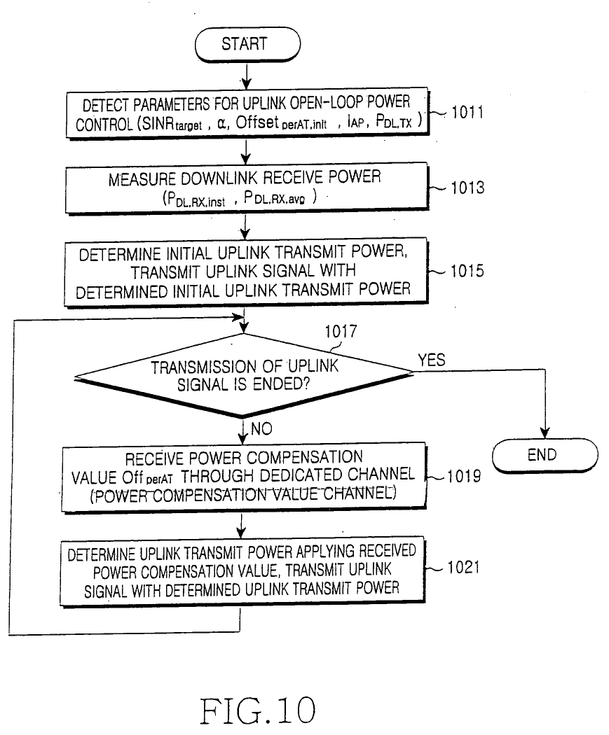

FIG. 10 is a flow diagram schematically illustrating the uplink open-loop transmit power control operation of the AT in the IEEE 802.16e communication system according to the second embodiment of the present invention. The uplink open-loop transmit power control operation of the AT according to the second embodiment of the present invention is identical to that according to the first embodiment of the present invention as described in FIG. 6, except that the power compensation value Offset_{perAT} is received through the power compensation value channel instead of the control message. That is, operations of steps 1011, 1013, 1015, 1017, and 1021 as illustrated in FIG. 10 are identical to those of steps 611, 613, 615, 617, and 621 as illustrated in FIG. 6. However, in step 619 of FIG. 6, the power compensation value Offset_{perAT} is received through the control message, but, in step 1019 of FIG. 10, the power compensation value Offset_{perAT} is received through the power compensation value channel.

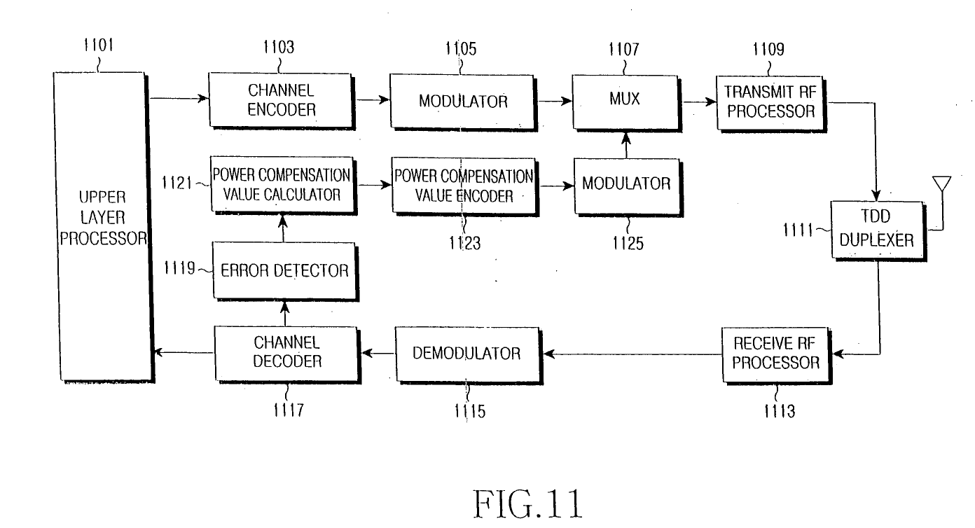

FIG. 11 is a block diagram schematically illustrating the AP in the IEEE 802.16e communication system according to the second embodiment of the present invention. Referring to FIG. 11, the AP includes an upper layer processor 1101, a channel encoder 1103, a modulator 1105, a multiplexer (MUX) 1107, a transmit RF processor 1109, a TDD duplexer 1111, a receive RF processor 1113, a demodulator 1115, a channel decoder 1117, an error detector 1119, a power compensation value calculator 1121, a power compensation value encoder 1123, and a modulator 1125.

The upper layer processor 1101 detects a control message to be transmitted to an AT and outputs the control message to the channel encoder 1103. The control message includes parameters for uplink open-loop transmit power control of the AT, i.e., the target SINR SINR_{target}, the weighted value α, the initial power compensation value Offset_{perAT,init}, the AP interference I_{AP}, and the downlink transmit power P_{DL,TX}. In the second embodiment of the present invention, because the power compensation value Offset_{perAT} is transmitted through the dedicated channel, i.e., the power compensation value channel, the control message does not include the power compensation value Offset_{perAT}. The channel encoder 1103 encodes the control message by a preset encoding scheme and outputs the encoded control message to the MUX 1107.

Further, the TDD duplexer 1111 outputs signals received through an antenna to the receive RF processor 1113. The receive RF processor 1113 includes a filter, a front end unit, etc., converts the signals output from the TDD duplexer 1111 into baseband signals, and outputs the baseband signals to the demodulator 1115. The demodulator 1115 inputs the signals output from the receive RF processor 1113, demodulates the signals by a demodulation scheme corresponding to the modulation scheme employed by the AT, and outputs the demodulated signals to the channel decoder 1117. The channel decoder 1117 inputs the signals output from the demodulator 1115, decodes the signals by a decoding scheme corresponding to the encoding scheme employed by the AT, and outputs the decoded signals to the upper layer processor 1101 and the error detector 1119.

The error detector 1119 detects if an error has occurred in the signals output from the channel decoder 1117, i.e., the packet data transmitted from the AT, and outputs the detection result to the power compensation value calculator 1121. The power compensation value calculator 1121 calculates the power compensation value Offset_{perAT} according to the detection result output from the error detector 1119, and outputs the power compensation value Offset_{perAT} to the power compensation value encoder 1123. Because the power compensation value Offset_{perAT} is calculated as expressed by Equation (7), a detailed description will be omitted here.

The power compensation value encoder 1123 encodes the power compensation value Offset_{perAT} output from the power compensation value calculator 1121 by a preset encoding scheme, and outputs the encoded signals to the modulator 1125. The encoding scheme is applied to the power compensation value channel. The modulator 1125 inputs the signals output from the power compensation value encoder 1123, modulates the signals by a preset modulation scheme, and outputs the modulated signals to the MUX 1107. The modulation scheme is applied to the power compensation value channel.

The MUX 1107 inputs and multiplexes the signals output from the modulator 1105 and the modulator 1125, and outputs the multiplexed signals to the transmit RF processor 1109. The transmit RF processor 1109 includes a filter, a front end unit, etc., inputs the signals output from the MUX 1107, RF-processes the signals, such that the signals can be transmitted to the air, and outputs the processed signals to the TDD duplexer 1111. The TDD duplexer 1111 transmits the signals output from the transmit RF processor 1109 via the antenna in a corresponding time slot.

It is noted that FIG. 11 does not illustrate the construction of a separated element, i.e., a FFT and an IFFT, for application of the OFDM scheme and the OFDMA scheme.

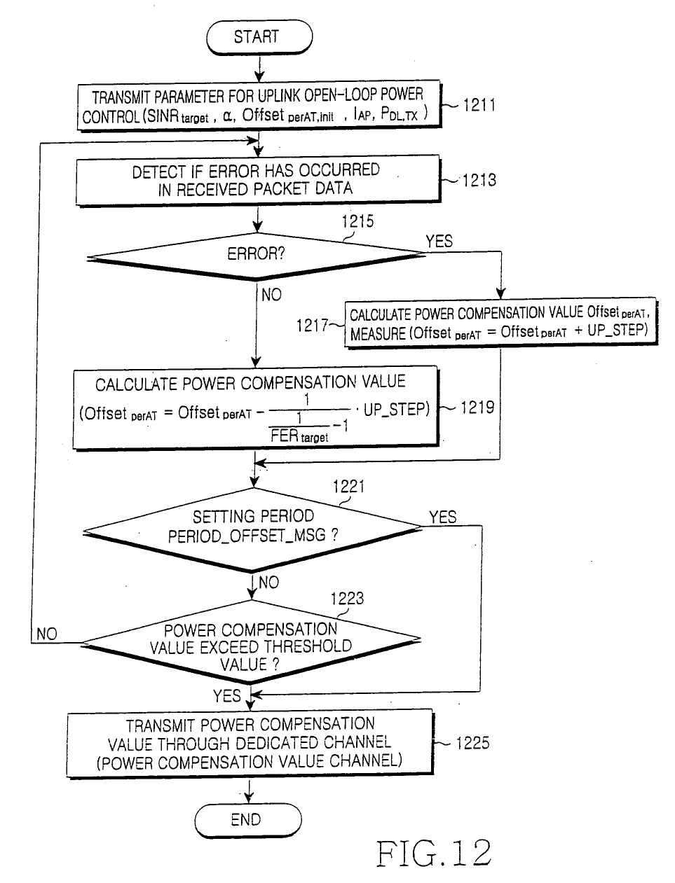

FIG. 12 is a flow diagram schematically illustrating the uplink open-loop transmit power control operation of the AP in the IEEE 802.16e communication system according to the second embodiment of the present invention. The uplink open-loop transmit power control operation of the AP according to the second embodiment of the present invention is identical to that according to the first embodiment of the present invention as described in FIG. 8, except that the power compensation value Offset_{perAT} is transmitted through the power compensation value channel, instead of the control message. That is, operations of steps 1211, 1213, 1215, 1217, 1219, 1221, and 1223 as illustrated in FIG. 12 are identical to those of steps 811, 813, 815, 817, 819, 821, and 823 as illustrated in FIG. 8. However, in step 825 of FIG. 8, the power compensation value Offset_{perAT} is transmitted through the control message, but, in step 1225 of FIG. 12, the power compensation value Offset_{perAT} is transmitted through the power compensation value channel.

As described above, according to the present invention, in a mobile communication system using a TDD scheme, a power compensation value is adaptively applied to channel conditions of each AT in order to control uplink transmit power using an open-loop power control scheme, such that efficient uplink transmit power control can be performed. More specifically, according to the present invention, an AP feedbacks a power compensation value corresponding to channel conditions of each AT, so that each AT can use uplink transmit power according to its own channel condition. Therefore, transmit power resources can become more efficient.

Further, according to the present invention, each AT use uplink transmit power proper for its own channel condition, such that it is possible to prevent interference influencing other ATs due to excessive transmit power from occurring. Consequently, system quality can be improved.

Although preferred embodiments of the present invention have been described for illustrative purposes, those skilled in the art will appreciate that various modifications, additions, and substitutions are possible, without departing from the scope and spirit of the present invention as disclosed in the accompanying claims, including the full scope of equivalents thereof.

What is claimed is:

1. A method for controlling uplink transmit power by an Access Terminal (AT) in a mobile communication system using a Time Division Duplexing (TDD) scheme, the method comprising the steps of:
determining initial uplink transmit power;
transmitting uplink signals to an Access Point (AP) using the determined initial uplink transmit power;
receiving downlink signals from the AP;
measuring receive power of the received downlink signals;
detecting a power compensation value from the received downlink signals in order to compensate for the uplink transmit power, the power compensation value being determined according to whether an error has occurred in the uplink signals; and
adjusting the uplink transmit power according to the measured receive power and the detected power compensation value.

2. The method in claim 1, wherein the step of determining the initial uplink transmit power comprises the steps of:
receiving the downlink signals from the AP;
detecting a Signal-to-Interference Noise Ratio (SINR) being targeted by an AT, interference of the AP, transmit power of the downlink signals, and an initial value of the power compensation value;
measuring the receive power of the received downlink signals; and
determining the initial uplink transmit power in consideration of the target SINR, the interference of the AP, the transmit power of the downlink signals, the initial value of the power compensation value, and the receive power.

3. The method in claim 2, wherein the uplink transmit power is adjusted according to the receive power and the power compensation value in consideration of the target SINR, the interference of the AP, the transmit power of the downlink signals, the power compensation value, and the receive power.

4. The method in claim 3, wherein the power compensation value is obtained by adding a preset step value to the previous power compensation value, when the error has occurred in the uplink signals.

5. The method in claim 3, wherein the power compensation value is obtained by subtracting a value, which has reflected a preset step value by a preset ratio, from the previous power compensation value, when the error has not occurred in the uplink signals.

6. A method for controlling uplink transmit power of an Access Terminal (AT) by an Access Point (AP) in a mobile communication system using a Time Division Duplexing (TDD) scheme, the method comprising the steps of:
transmitting downlink signals including parameters required for determining an initial value of the uplink transmit power of an AT;
when uplink signals are received from the AT, detecting if an error has occurred in the uplink signals;
determining a power compensation value for compensating for the uplink transmit power according to whether the error has occurred in the uplink signals; and
transmitting downlink signals including the power compensation value.

7. The method in claim 6, wherein the parameter includes a Signal-to-Interference Noise Ratio (SINR) being targeted by the AT, interference of an AP, transmit power of the downlink signals, and an initial value of the power compensation value.

8. The method in claim 7, wherein the step of determining the power compensation value comprises adding a preset step value to the previous power compensation value when the error has occurred in the uplink signals.

9. The method in claim 7, wherein the step of determining the power compensation value comprises subtracting a value, which has reflected a preset step value by a preset ratio, from the previous value of the power compensation value, when the error has not occurred in the uplink signals.

10. The method in claim 6, wherein the step of transmitting the downlink signals including the power compensation value is performed only when the power compensation value exceeds a preset threshold value.

11. The method in claim 6, wherein the step of transmitting the downlink signals including the power compensation value is performed only when a preset setting period has arrived.

12. An apparatus for controlling uplink transmit power by an Access Terminal (AT) in a mobile communication system using a Time Division Duplexing (TDD) scheme, the apparatus comprising:
a transmitter for transmitting uplink signals to an Access Point (AP) using initial uplink transmit power determined by a predetermined control, and transmitting uplink signals to the AP using uplink transmit power adjusted by a predetermined control;
a receiver for receiving downlink signals from the AP and detecting a power compensation value for compensating for the uplink transmit power, the power compensation value being determined according to whether an error has occurred in the uplink signals; and
a transmit power controller for determining the initial uplink transmit power, and controlling the uplink transmit power to be adjusted according to receive power and the power compensation value.

13. The apparatus in claim 12, wherein the transmit power controller determines the initial uplink transmit power in consideration of a Signal-to-Interference Noise Ratio (SINR) being targeted by the AT, interference of the AP, transmit power of the downlink signals, an initial value of the power compensation value, and the receive power of the downlink signals, which are detected from the downlink signals.

14. The apparatus in claim 13, wherein the transmit power controller controls the uplink transmit power to be adjusted in consideration of the target SINR, the interference of the AP, the transmit power of the downlink signals, the power compensation value, and the receive power.

15. The apparatus in claim 14, wherein the power compensation value is obtained by adding a preset step value to the previous power compensation value when the error has occurred in the uplink signals.

16. The apparatus in claim 14, wherein the power compensation value is obtained by subtracting a value, which has reflected a preset step value by a preset ratio, from the previous power compensation value, when the error has not occurred in the uplink signals.

17. An apparatus for controlling uplink transmit power of an Access Terminal (AT) by an Access Point (AP) in a mobile communication system using a Time Division Duplexing (TDD) scheme, the apparatus comprising:
a transmitter for transmitting downlink signals including parameters required for determining an initial value of the uplink transmit power of an AT, and transmitting downlink signals including a power compensation value for compensating for the uplink transmit power determined by a predetermined control;
a receiver for receiving uplink signals from the AT, and detecting if an error has occurred in the uplink signals; and
a power compensation value calculator for determining the power compensation value for compensating for the uplink transmit power according to whether the error has occurred in the uplink signals.

18. The apparatus in claim 17, wherein the parameter comprises at least one of a Signal-to-Interference Noise Ratio (SINR) being targeted by the AT, interference of an AP, transmit power of the downlink signals, and an initial value of the power compensation value, the target SINR being targeted by the AT.

19. The apparatus in claim 18, wherein power compensation value calculator determines the power compensation value by adding a preset step value to the previous power compensation value when the error has occurred in the uplink signals.

20. The apparatus in claim 18, wherein the power compensation value calculator determines the power compensation value by subtracting a value, which has reflected a preset step value by a preset ratio, from the previous value of the power compensation value, when the error has not occurred in the uplink signals.

21. The apparatus, in claim 17, wherein the transmitter transmits the downlink signals including the power compensation value only when the power compensation value exceeds a preset threshold value.

22. The apparatus in claim 17, wherein the transmitter transmitting the downlink signals including the power compensation value only when a preset setting period has arrived.
